(19) United States
(12) Patent Application Publication
(10) Pub. No.: US 2016/0275847 A1
(43) Pub. Date: Sep. 22, 2016

(54) SHIFT REGISTER DEVICE AND DISPLAY APPARATUS

(71) Applicants: HannStar Display (Nanjing) Corporation, Nanjing (CN); HannStar Display Corporation, Taipei City (TW)

(72) Inventors: Sung-Chun LIN, Tainan City (TW); Hsuan-Chen LIU, Kaohsiung City (TW); Chien-Ting CHAN, Tainan City (TW)

(21) Appl. No.: 15/071,217

(22) Filed: Mar. 16, 2016

(30) Foreign Application Priority Data
Mar. 20, 2015 (CN) 201510124736.4

(51) Int. Cl. G09G 3/20; G06F 1/04

(52) U.S. Cl. CPC G09G 3/2085; G06F 1/04; G09G 2310/0286; G09G 2310/08; G09G 2330/021; G09G 2300/08; G09G 2330/028

(57) ABSTRACT

The present invention discloses a shift register device and a display apparatus. The shift register device includes N stage shift registers. Each shift register includes a control circuit, an output stage circuit and a bias circuit. In the i-th shift register, the control circuit receives a first control signal, a first output signal and a second output signal, and outputs a second control via a first node. The output stage circuit receives a first clock signal, a second clock signal and the second control signal, and outputs an i-th output signal via a second node. The bias circuit includes a capacitor and a transistor. A first terminal of the capacitor receives the first clock signal. The drain of the transistor is coupled to a second terminal of the capacitor, the gate of the transistor is coupled to the second node, and the source of the transistor receives a reference voltage.

### RELATED APPLICATIONS

This application claims priority to Chinese Patent Application Serial Number 201510124736.4, filed on Mar. 20, 2015, which is herein incorporated by reference.

### BACKGROUND

1. Field of the Invention

The present invention relates to a shift register device and a display apparatus, and more particularly to a shift register device and a display apparatus which are able to reduce power consumption.

2. Description of Related Art

A flat panel display device, such as a liquid crystal display (LCD) device or an organic light-emitting diode (OLED) display device, usually has a lot of shift registers for controlling gray levels of all pixels in the display device displayed at the same time point. In response to energy issues followed by all sectors of the industry, the level of power consumption has also to be considered in a circuit design of a display device. Thus, how to design an electrical circuit of a shift register for saving power has become one of the major objectives for those skilled in the art. On the other hand, the accuracy of signals correspondingly outputted at each time point has to be considered in an electrical circuit design of a shift register for ensuring image display quality of a display device with such shift register.

### SUMMARY

The objective of the present invention is to provide a shift register device and a display apparatus for reducing power consumption and avoiding abnormal operation to ensure operational reliability.

One aspect of the present invention is directed to a shift register device. The shift register device includes N number of shift registers. An i-th shift register among the N number of shift registers includes a control circuit, an output stage circuit and a bias circuit. The control circuit is configured to receive a first control signal, a first input signal and a second input signal and output a second control signal via a first node. The output stage circuit is configured to receive a first clock signal, a second clock signal and the second control signal and output an i-th output signal via a second node. The bias circuit includes a first capacitor and a first transistor. The first capacitor has a first terminal configured to receive the first clock signal. The first transistor has a drain coupled to a second terminal of the first capacitor and configured to provide the first control signal, a gate coupled to the second node and a source configured to receive a reference voltage.

In one embodiment of the present invention, N is an integer greater than or equal to 5, the first input signal is an (i−2)th output signal outputted by an (i−2)th shift register among the N number of shift registers, the second input signal is an (i+2)th output signal outputted by an (i+2)th shift register among the N number of shift registers, wherein i is an integer greater than or equal to 3 and less than or equal to (N−2).

In one embodiment of the present invention, the first input signal is a starting signal, and the second input signal is an (i+2)th output signal outputted by an (i+2)th shift register among the N number of shift registers, wherein i is 1 or 2.

In one embodiment of the present invention, N is an integer greater than or equal to 5, the first input signal is an (i−2)th output signal outputted by an (i−2)th shift register among the N number of shift registers, and the second input signal is an ending signal, wherein i is N or (N−1).

In one embodiment of the present invention, the control circuit includes a second transistor, a third transistor and a fourth transistor. The second transistor has a drain coupled to the first node, a gate configured to receive the first input signal and a source configured to receive a forward voltage. The third transistor has a drain coupled to the drain of the second transistor, a gate configured to receive the second input signal and a source configured to receive a backward voltage. The fourth transistor has a drain coupled to the drain of the second transistor, a gate coupled to the drain of the first transistor and a source configured to receive the reference voltage.

In one embodiment of the present invention, the output stage circuit includes a fifth transistor, a second capacitor, a sixth transistor and a seventh transistor. The fifth transistor has a drain coupled to the second node, a gate coupled to the first node and a source configured to receive the first clock signal. The second capacitor has a first terminal coupled to the first node and a second terminal coupled to the second node. The sixth transistor has a drain coupled to the second node, a gate coupled to the drain of the first transistor and a source configured to receive the reference voltage. The seventh transistor has a drain coupled to the second node a gate configured to receive the second clock signal and a source configured to receive the reference voltage.

In one embodiment of the present invention, the shift register device further comprises four clock signal lines, wherein two of the clock signal lines are coupled to a j-th shift register among the N number of shift registers, and the other two of the clock signal lines are coupled to a (j+1)th shift register among the N number of shift registers, wherein j is an odd integer less than N.

In one embodiment of the present invention, the shift register device further comprises two starting signal lines, wherein one of the starting signal lines is coupled to a first shift register among the N number of shift registers, and the other of the starting signal lines is coupled to a second shift register among the N number of shift registers.

In one embodiment of the present invention, the shift register device further comprises two ending signal lines, wherein one of the ending signal lines is coupled to an (N−1)th shift register among the N number of shift registers, and the other of the ending signal lines is coupled to an N-th shift register among the N number of shift registers.

In one embodiment of the present invention, N is an integer multiple of 4.

Another aspect of the present invention is directed to a display apparatus. The display apparatus includes a display panel and a shift register device. The shift register device is configured to drive the display panel and includes N number of shift registers. An i-th shift register among the N number of shift registers includes a control circuit, an output stage circuit and a bias circuit. The control circuit is configured to receive a first control signal, a first input signal and a second input signal and output a second control signal via a first node. The output stage circuit is configured to receive a first clock signal, a second clock signal and the second control signal and output an i-th output signal via a second node. The bias circuit includes a first capacitor and a first transistor. The first capacitor has a first terminal configured to receive the first clock signal. The first transistor has a drain coupled to a second terminal of the first capacitor and configured to provide the first control signal, a gate coupled to the second node and a source configured to receive a reference voltage.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings.

FIG. 1 is a schematic diagram of a display apparatus.

FIG. 2 is schematic diagram of a shift register device in accordance with one embodiment of the present invention.

FIG. 3 is a circuit diagram of a shift register of the shift register device in FIG. 2.

FIG. 4 is a time sequential diagram of the first stage shift register in FIG. 2.

FIG. 5 is a time sequential diagram of the second stage shift register in FIG. 2.

### DETAILED DESCRIPTION

The detailed explanation of the present invention is described as following. The described preferred embodiments are presented for purposes of illustrations and description, and they are not intended to limit the scope of the present invention.

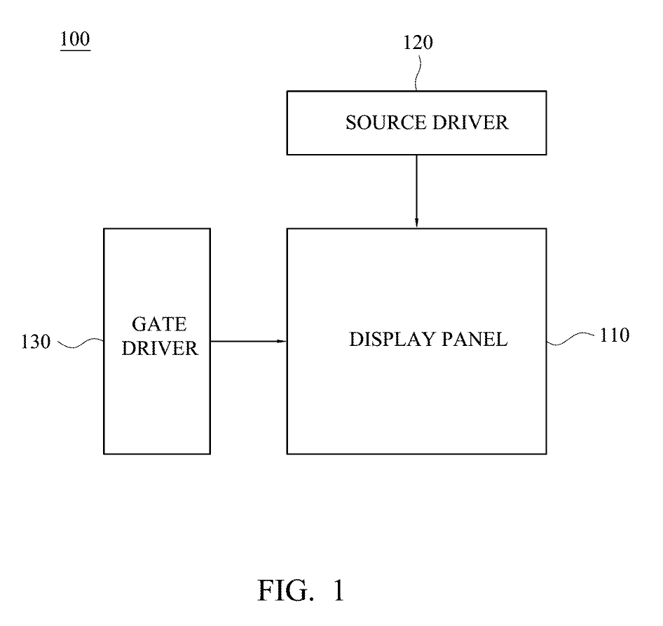

Please refer to FIG. 1, FIG. 1 is a schematic diagram of a display apparatus 100. The display apparatus 100 includes a display panel 110, a source driver 120 and a gate driver 130. The display penal 110 includes pixels arranged in a matrix for collectively displaying an image. The display penal 110 may be any type of a liquid crystal display (LCD) panel, such as a twisted nematic (TN) type LCD panel, an in-plane switching (IPS) type LCD panel, a fringe-field switching (FFS) type LCD panel or a vertical alignment (VA) type LCD panel, or may alternative be an organic light emitting diode (OLED) display panel. The source driver 120 is electrically connected to the display penal 110, and is configured to convert image data to source driving signals and transmit the source driving signals to the display penal 110. The gate driver 130 is configured to generate and transmit gate driving signals to the display penal 110. The display penal 110 receives the source driving signals and the gate driving signals to display images.

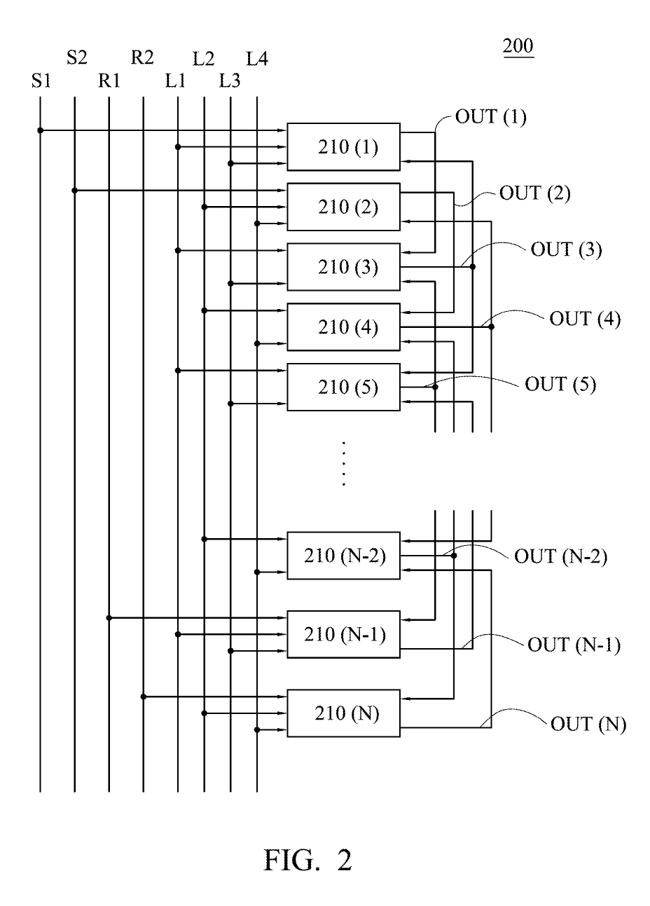

Please refer to FIG. 2, FIG. 2 is schematic diagram of a shift register device 200 in accordance with one embodiment of the present invention. The shift register device 200 includes clock signal lines L1-L4, starting signal lines S1-S2, ending signal lines R1-R2 and N stage shift registers 210(1)-210(N). In some embodiments, N is an integer greater than or equal to 5. In addition, in some embodiments, N is a multiple of 4. The clock signal lines L1-L4 are configured to respectively provide clock signals C1-C4 for the corresponding shift registers 210(1)-210(N). In FIG. 2, the clock signal lines L1 and L3 respectively provide the clock signals C1 and C3 to the odd-numbered stage shift registers 210(1), 210(3), . . . , 210(N−1), while the clock signal lines L2, L4 respectively provide the clock signals C2 and C4 to the even-numbered stage shift registers 210(2), 210(4), . . . , 210(N). In addition, the starting signal line S1 provides a starting signal STV1 to the first stage shift register 210(1), the starting signal line S2 provides a starting signal STV2 to the second stage shift register 210(2), the ending signal line R1 provides an ending signal to the (N−1)th stage shift register 210(N−1), and the ending signal line R2 provides an ending signal RSTV2 to the N-th shift register 210(N). The shift registers 210(1)-210(N) respectively generate output signals OUT(1)-OUT(N). The output signals OUT(1), OUT(2) are respectively inputted to the third stage shift register 210(3) and the fourth stage shift register 210(4), the output signals OUT(N−1), OUT(N) are respectively inputted to the (N−3)th stage shift register 210(N−3) and the (N−2)th stage shift register 210(N−2), and each of the output signals OUT(3)-OUT(N−2) is inputted to the shift registers which are second previous to and second next to the respective one of the shift registers 210(3)-210(N−2). For illustration, the output signal OUT(3) is inputted to the shift register 210(1) and the shift register 210(5).

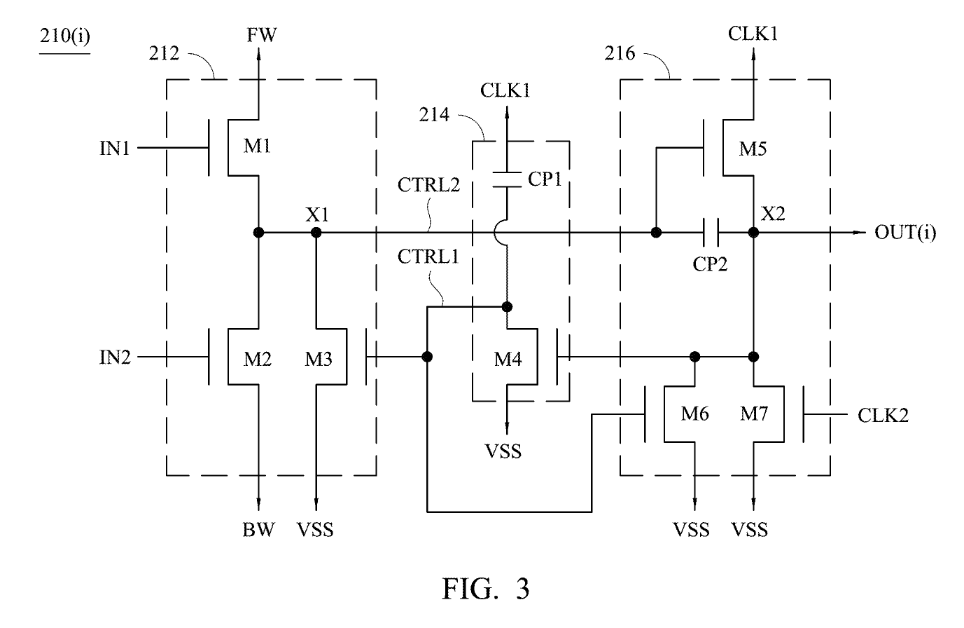

FIG. 3 is a circuit diagram of the i-th shift register 210(i) of the shift register device 200 in FIG. 2, where i is an integer from 1 to N. The i-th stage shift register 210(i) includes a control circuit 212, a bias circuit 214 and an output stage circuit 216. The control circuit 212 is configured to receive a control signal CTRL1 and input signals IN1-IN2, and to output a control signal CTRL2 via a node X1. Specifically, the control circuit 212 includes transistors M1-M3. The drain of the transistor M1 is coupled to the node X1, the gate of the transistor M1 is configured to receive the input signal IN1, and the source of the transistor M1 is configured to receive a forward voltage FW. The drain of the transistor M2 is coupled to the drain of the transistor M1, the gate of the transistor M2 is configured to receive the input signals IN2, and the source of the transistor M2 is configured to receive a backward voltage BW. The drain of the transistor M3 is coupled to the drain of the transistor M2, the gate of the transistor M3 is coupled to the bias circuit 214, and the source of the transistor M3 is configured to receive a reference voltage VSS. In the embodiments of the present invention, the reference voltage VSS is low level.

The bias circuit 214 includes a capacitor CP1 and a transistor M4. The first terminal of the capacitor CP1 is configured to receive a clock signal CLK1. The drain of the transistor M4 is coupled to the second terminal of the capacitor CP1, providing the control signal CTRL1 to the gate of the transistor M3 and the output stage circuit 216. The gate of the transistor M4 is coupled to a node X2, and the source of the transistor M4 is configured to receive the reference voltage VSS.

The output stage circuit 216 includes a capacitor CP2 and transistors M5-M7. The drain of the transistor M5 is coupled to the node X2, the gate of the transistor M5 is coupled to the node X1, and the source of the transistor M5 is configured to receive the clock signal CLK1. The first terminal of the capacitor CP2 is coupled to the node X1, and the second terminal of the capacitor CP2 is coupled to the node X2. That is, the capacitor CP2 is coupled between the gate and the drain of the transistor M5. The drain of the transistor M6 is coupled to the node X2, the gate of the transistor M6 is coupled to the drain of the transistor M4, and the source of the transistor M6 is configured to receive the reference voltage VSS. The drain of the transistor M7 is coupled to the node X2, the gate of the transistor M7 is configured to receive the clock signal CLK2, and the source of the transistor M7 is configured to receive the reference voltage VSS.

If the shift register 210(i) illustrated in FIG. 3 is the first stage shift register (i.e. i=1), the input signal IN1 is the starting signal STV1, the input signal IN2 is the third stage output signal OUT(3) outputted by the third stage shift register 210(3), the clock signal CLK1 is the clock signal C1, and the clock signal CLK2 is the clock signal C3.

If the shift register 210(i) illustrated in FIG. 3 is the second stage shift register (i.e. i=2), the input signal IN1 is the starting signal STV2, the input signal IN2 is the fourth stage output signal OUT(4) outputted by the fourth stage shift register 210(4), the clock signal CLK1 is the clock signal C2, and the clock signal CLK2 is the clock signal C4.

If the shift register 210(i) illustrated in FIG. 3 is the (N−1)th stage shift register (i.e. i=N−1), the input signal IN1 is the (N−3)th stage output signal OUT(N−3) outputted by the (N−3)th stage shift register 210(N−3), the input signal IN2 is the ending signal RSTV1, the clock signal CLK1 is the clock signal C3, and the clock signal CLK2 is the clock signal C1.

If the shift register 210(i) illustrated in FIG. 3 is the N-th stage shift register (i.e. i=N), the input signal IN1 is the (N−2)th stage output signal OUT(N−2) outputted by the (N−2)th stage shift register 210(N−2), the input signal IN2 is the ending signal RSTV2, the clock signal CLK1 is the clock signal C4, and the clock signal CLK2 is the clock signal C2.

If the shift register 210(i) illustrated in FIG. 3 is the third stage to the (N−2)th stage shift register (i.e. i=N), the input signal IN1 is the (i−2)th stage output signal OUT(i−2) outputted by the (i−2)th stage shift register 210(i−2), and the input signal IN2 is the (i+2)th stage output signal OUT(i+2) outputted by the (i+2)th stage shift register 210(i+2). The clock signals CLK1 and CLK2 vary with the stage number of the shift register. For illustration, if i=3, the clock signal CLK1 is the clock signal C3, and the clock signal CLK2 is the clock signal C1. If i=4, the clock signal CLK1 is the clock signal C4, and the clock signal CLK2 is the clock signal C2.

As can be seen from the above, the clock signal CLK1 in the shift registers 210(1)-210(4) are sequentially the clock signals C1, C2, C3, C4, and the clock signal CLK2 in the shift registers 210(1)-210(4) are sequentially the clock signals C3, C4, C1, C2. In this embodiment, the clock signals CLK1 and CLK2 sequentially change with a period of four shift registers. In other words, the clock signal CLK1 in the shift registers 210(M−3)-210(M) (M is an integer multiple of 4) are sequentially the clock signal C1, C2, C3 and C4, and the clock signal CLK2 in the shift registers 210(M−3)-210(M) are sequentially the clock signal C3, C4, C1 and C2.

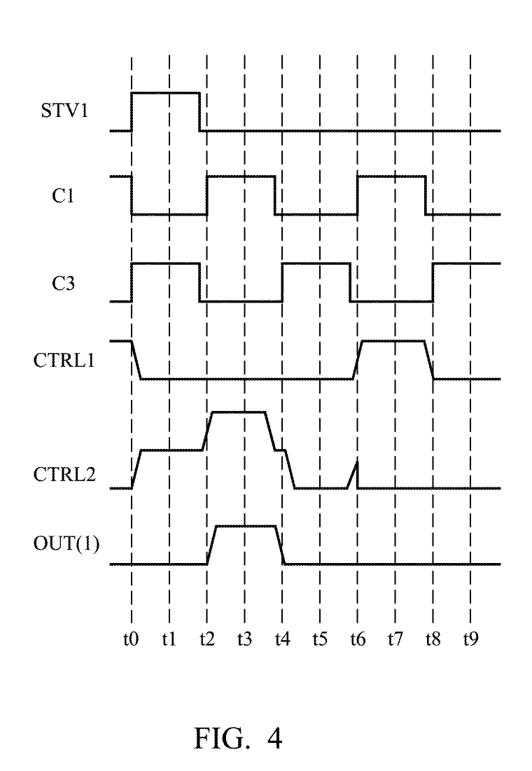

In the following embodiment, the forward voltage FW and the backward voltage BW are illustrated as high level and low level, respectively. Please refer to FIG. 4, FIG. 4 is a time sequential diagram of the first stage shift register 210(1) in FIG. 2. As shown in FIG. 4, at time t0, the starting signal STV1 rises to high level, the clock signal C1 falls to low level, and the clock signal C3 rises to high level. At this time, in the first stage shift register 210(1), the transistor M1 is turned on by the starting signal STV1, such that the voltage level of the control signal CTRL2 rises. The voltage level of the control signal CTRL1 falls because the clock signal C1 falls to low level. Although transistor M5 is turned on by the control signal CTRL2, the output signal OUT(1) still remains low level because the clock signal C1 falls to low level.

At time t2, the starting signal STV1 falls to low level, the clock signal C1 rises to high level, and the clock signal C3 falls to low level. At this time, in the first stage shift register 210(1), the transistor M5 still remains on, and the output signal OUT(1) rises to high level because the clock signal C1 rises to high level. The voltage level of the control signal CTRL2 rises because of the coupling effect of the capacitor CP2. The transistor M4 is turned on because the output signal OUT(1) rises to high level, such that the control signal CTRL1 remains at low level. Meanwhile, the transistors M1, M2, M3, M6 and M7 are turned off.

At time t4, the dock signal C1 falls to low level, and the dock signal C3 rises to high level. At this time, in the first stage shift register 210(1), the output signal OUT(1) falls to low level because the clock signal C1 falls to low level. Meanwhile, the output signal OUT(3) of the third stage shift register 210(3) rises to high level, such that the transistor M2 is turned on. As such, in the first stage shift register 210(1), the voltage level of the control signal CTRL2 falls by the coupling effect of the capacitor CP2 first, and then further falls to low level by the transistor M2 being turned on.

At time t6, the clock signal C1 rises to high level, and the clock signal C3 falls to low level. At this time, in the first stage shift register 210(1), the voltage of the control signal CTRL1 rises because of the coupling effect of the capacitor CP1, such that the transistors M3 and M6 are turned on and the output signal OUT(1) remains at low level. Meanwhile, a surge of the control signal CTRL2 appears because the clock signal C1 rises to high level, and then the voltage level of the control signal CTRL2 falls because the transistor M3 is turned on. In the first stage shift register 210(1), the switching status of the transistor M4 is controlled by the output signal OUT(1), and thus, the transistor M4 still remains off instead of being affected by the surge of the control signal CTRL2 to induce instantaneous conduction, thereby avoiding unnecessary power consumption in the bias circuit 214 and abnormal operation of the shift register device 200 by erroneous operation of the transistor M4.

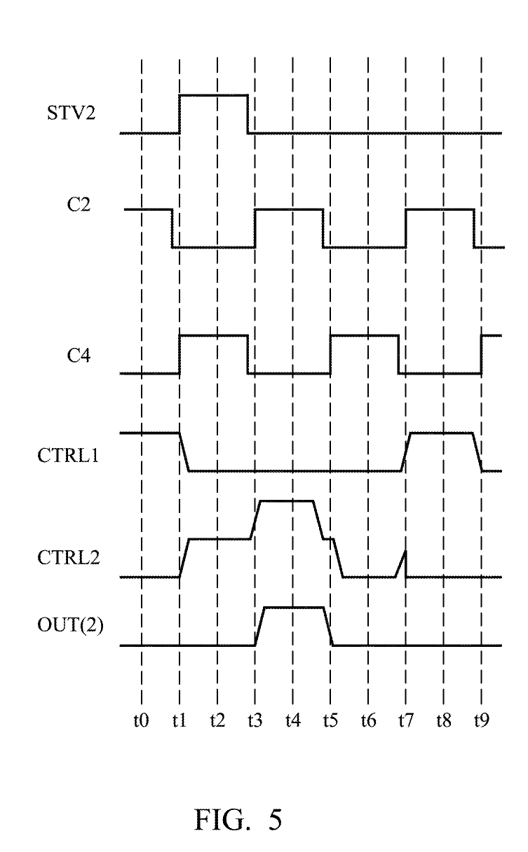

Please refer to FIG. 5, FIG. 5 is a time sequential diagram of the second stage shift register 210(2) in FIG. 2. As shown in FIG. 5, at time t1, the starting signal STV2 rises to high level, the clock signal C2 falls to low level, and the dock signal C4 rises to high level. At this time, in the second stage shift register 210(2), the transistor M1 is turned on by the starting signal STV2, such that the voltage level of the control signal CTRL2 rises. The voltage level of the control signal CTRL1 falls because the clock signal C2 falls to low level. Although the transistor M5 is turned on by the control signal CTRL2, the output signal OUT(2) still remains low level because the clock signal C2 falls to low level.

At time t3, the starting signal STV2 falls to low level, the clock signal C2 rises to high level, and the clock signal C4 falls to low level. At this time, in the first stage shift register 210(2), the transistor M5 still remains on, and the output signal OUT(2) rises to high level because the clock signal C2 rises to high level. The voltage level of the control signal CTRL2 rises because of the coupling effect of the capacitor CP2. The transistor M4 is turned on because the output signal OUT(2) rises to high level, such that the control signal CTRL1 remains at low level. Meanwhile, the transistors M1, M2, M3, M6 and M7 are turned off.

At time t5, the clock signal C2 falls to low level, and the clock signal C4 rises to high level. At this time, in the second stage shift register 210(2), the output signal OUT(2) falls to low level because the clock signal C2 falls to low level. Meanwhile, the output signal OUT(4) of the fourth stage shift register 210(4) rises to high level, such that the transistor M2 is turned on. As such, in the second stage shift register 210(2), the voltage level of the control signal CTRL2 falls by the coupling effect of the capacitor CP2 first, and then further falls to low level by the transistor M2 being turned on.

At time t7, the clock signal C2 rises to high level, and the clock signal C4 falls to low level. At this time, in the second stage shift register 210(2), the voltage level of the control signal CTRL1 rises because of the coupling effect of the capacitor CP1, such that the transistors M3 and M6 are turned on and the output signal OUT(2) remains at low level. Meanwhile, a surge of the control signal CTRL2 appears because the clock signal C2 rises to high level, and then the voltage level of the control signal CTRL2 falls because the transistor M3 is turned on.

Similarly, in the second stage shift register 210(2), the switching status of the transistor M4 is controlled by the output signal OUT(2), and thus, the transistor M4 still remains off instead of being affected by the surge of the control signal CTRL2 to induce instantaneous conduction, thereby avoiding unnecessary power consumption in the bias circuit 214 and abnormal operation of the shift register device 200 by erroneous operation of the transistor M4.

In the foregoing embodiments, only the first stage shift register 210(1) and the second stage shift register 210(2) are illustrated. The operating method of the third stage to the N-th stage shift registers 210(3)-210(N) are similar to that of the first stage shift register 210(1) and the second stage shift register 210(2) and can be easily known by those skilled in the art by referencing the aforementioned embodiments, and thus the detailed description is not repeated herein. In addition, the forward voltage FW and the backward voltage BW may be changed to be lower level and high level, respectively, such that the output signals OUT(1)-OUT(N) of the shift register device 200 sequentially rise to high level in a reverse manner. That is, the output signal OUT(N) rises to high level first, and then the output signals OUT(N−1)-OUT(1) sequentially rise to high level.

Summing the above, the shift register device and the display apparatus using the same of the present invention can reduce power consumption and avoid abnormal operation of the shift register device by erroneous operation of the transistor in the shift register for ensuring operational reliability of the shift register device, thereby improving the image display quality of the display apparatus.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims.

What is claimed is:

1. A shift register device, comprising:
N number of shift registers, wherein an i-th shift register among the N number of shift registers comprises:
a control circuit configured to receive a first control signal, a first input signal and a second input signal and output a second control signal via a first node;
an output stage circuit configured to receive a first clock signal, a second clock signal and the second control signal and output an i-th output signal via a second node; and
a bias circuit comprising:
a first capacitor having a first terminal configured to receive the first clock signal; and
a first transistor having a drain coupled to a second terminal of the first capacitor and configured to provide the first control signal, a gate coupled to the second node and a source configured to receive a reference voltage.

2. The shift register device of claim 1, wherein N is an integer greater than or equal to 5, the first input signal is an (i−2)th output signal outputted by an (i−2)th shift register among the N number of shift registers, the second input signal is an (i+2)th output signal outputted by an (i+2)th shift register among the N number of shift registers, wherein i is an integer greater than or equal to 3 and less than or equal to (N−2).

3. The shift register device of claim 1, wherein the first input signal is a starting signal, and the second input signal is an (i+2)th output signal outputted by an (i+2)th shift register among the N number of shift registers, wherein i is 1 or 2.

4. The shift register device of claim 1, wherein N is an integer greater than or equal to 5, the first input signal is an (i−2)th output signal outputted by an (i−2)th shift register among the N number of shift registers, and the second input signal is an ending signal, wherein i is N or (N−1).

5. The shift register device of claim 1, wherein the control circuit comprises:
a second transistor having a drain coupled to the first node, a gate configured to receive the first input signal and a source configured to receive a forward voltage;
a third transistor having a drain coupled to the drain of the second transistor, a gate configured to receive the second input signal and a source configured to receive a backward voltage; and
a fourth transistor having a drain coupled to the drain of the second transistor, a gate coupled to the drain of the first transistor and a source configured to receive the reference voltage.

6. The shift register device of claim 1, wherein the output stage circuit comprises:
a fifth transistor having a drain coupled to the second node, a gate coupled to the first node and a source configured to receive the first clock signal;
a second capacitor having a first terminal coupled to the first node and a second terminal coupled to the second node;
a sixth transistor having a drain coupled to the second node, a gate coupled to the drain of the first transistor and a source configured to receive the reference voltage; and
a seventh transistor having a drain coupled to the second node, a gate configured to receive the second clock signal and a source configured to receive the reference voltage.

7. The shift register device of claim 1, wherein the shift register device further comprises four clock signal lines, wherein two of the clock signal lines are coupled to a j-th shift register among the N number of shift registers, and the other two of the clock signal lines are coupled to a (j+1)th shift register among the N number of shift registers, wherein j is an odd integer less than N.

8. The shift register device of claim 1, wherein the shift register device further comprises two starting signal lines, wherein one of the starting signal lines is coupled to a first shift register among the N number of shift registers, and the other of the starting signal lines is coupled to a second shift register among the N number of shift registers.

9. The shift register device of claim 1, wherein the shift register device further comprises two ending signal lines, wherein one of the ending signal lines is coupled to an (N−1)th shift register among the N number of shift registers, and the other of the ending signal lines is coupled to an N-th shift register among the N number of shift registers.

10. The shift register device of claim 1, wherein N is an integer multiple of 4.

11. A display apparatus, comprising:
a display panel; and
a shift register device configured to drive the display panel and comprising N number of shift registers, wherein an i-th shift register among the N number of shift registers comprises:
a control circuit configured to receive a first control signal, a first input signal and a second input signal and output a second control signal via a first node;
an output stage circuit configured to receive a first clock signal, a second clock signal and the second control signal and output an i-th output signal via a second node; and
a bias circuit comprising:
a first capacitor having a first terminal configured to receive the first clock signal; and
a first transistor having a drain coupled to a second terminal of the first capacitor and configured to provide the first control signal, a gate coupled to the second node and a source configured to receive a reference voltage.

12. The display apparatus of claim 11, wherein N is an integer greater than or equal to 5, the first input signal is an (i−2)th output signal outputted by an (i−2)th shift register among the N number of shift registers, the second input signal is an (i+2)th output signal outputted by an (i+2)th shift register among the N number of shift registers, wherein i is an integer greater than or equal to 3 and less than or equal to (N−2).

13. The display apparatus of claim 11, wherein the first input signal is a starting signal, and the second input signal is an (i+2)th output signal outputted by an (i+2)th shift register among the N number of shift registers, wherein i is 1 or 2.

14. The display apparatus of claim 11, wherein N is an integer greater than or equal to 5, the first input signal is an (i−2)th output signal outputted by an (i−2)th shift register among the N number of shift registers, and the second input signal is an ending signal, wherein i is N or (N−1).

15. The display apparatus of claim 11, wherein the control circuit comprises:
a second transistor having a drain coupled to the first node, a gate configured to receive the first input signal and a source configured to receive a forward voltage;
a third transistor having a drain coupled to the drain of the second transistor, a gate configured to receive the second input signal and a source configured to receive a backward voltage; and
a fourth transistor having a drain coupled to the drain of the second transistor, a gate coupled to the drain of the first transistor and a source configured to receive the reference voltage.

16. The display apparatus of claim 11, wherein the output stage circuit comprises:
a fifth transistor having a drain coupled to the second node, a gate coupled to the first node and a source configured to receive the first clock signal;
a second capacitor having a first terminal coupled to the first node and a second terminal coupled to the second node;
a sixth transistor having a drain coupled to the second node, a gate coupled to the drain of the first transistor and a source configured to receive the reference voltage; and
a seventh transistor having a drain coupled to the second node, a gate configured to receive the second clock signal and a source configured to receive the reference voltage.

17. The display apparatus of claim 11, wherein the shift register device further comprises four clock signal lines, wherein two of the clock signal lines are coupled to a j-th shift register among the N number of shift registers, and the other two of the clock signal lines are coupled to a (j+1)th shift register among the N number of shift registers, wherein j is an odd integer less than N.

18. The display apparatus of claim 11, wherein the shift register device further comprises two starting signal lines, wherein one of the starting signal lines is coupled to a first shift register among the N number of shift registers, and the other of the starting signal lines is coupled to a second shift register among the N number of shift registers.

19. The display apparatus of claim 11, wherein the shift register device further comprises two ending signal lines, wherein one of the ending signal lines is coupled to an (N−1)th shift register among the N number of shift registers, and the other of the ending signal lines is coupled to an N-th shift register among the N number of shift registers.

20. The display apparatus of claim 11, wherein N is an integer multiple of 4.
